(19) United States
(12) Patent Application Publication
(10) Pub. No.: US 2015/0290967 A1
(43) Pub. Date: Oct. 15, 2015

(54) Camouflage Design and Method

(71) Applicants: Jeffrey A. Laurell, Woodland Park, CO (US); John Scott Gillingham, Woodland Park, CO (US)

(72) Inventors: Jeffrey A. Laurell, Woodland Park, CO (US); John Scott Gillingham, Woodland Park, CO (US)

(73) Assignee: PHANTOM DESIGN, LLC, Woodland Park, CO (US)

(21) Appl. No.: 14/250,134

(22) Filed: Apr. 10, 2014

(51) Int. Cl. B44F 9/02

(52) U.S. Cl. CPC B44F 9/02

(57) ABSTRACT

A crypsis camouflage pattern for application to the surface area of an object, comprising a first color background ranging from slight to complete opaque, covering at least a portion of the surface area of the object and at least one additional color application, each superimposed over at least a portion of the surface area of the object and comprising a plurality of randomly scattered abstract forms, each of the applications being of a different color and each having varying degrees of transparency.

### BACKGROUND

Camouflage is as old as nature itself, that is, the art of utilizing a combination of materials, coloration or illumination for concealment, either by making living beings or objects difficult to see (crypsis), or by disguising them as something else (mimesis). The majority of camouflage methods for military personnel and hunters aim for crypsis by way of a general resemblance to the background. Since about 1800 military forces around the world have used various forms of camouflaged textile patterns to suit the need to match combat clothing to different kinds of terrain, such as woodland, snow and sand. However, the design of a pattern that is effective in all terrains has proved elusive.

The American Universal Camouflage Pattern of 2004 attempted to suit all environments, but was withdrawn after a few years of service. Terrain-specific patterns have been developed but are ineffective in other terrains. More recently pixellated shapes, are being used as camouflage patterns by the United States military. These designs use miniature swatches of color instead of large swatches, tending to mimic the dappled textures and rough boundaries found in natural settings. For example, MARPAT is a digital camouflage pattern in use with the United States Marine Corp, which design is the subject of U.S. Pat. No. 6,805,957. The Universal Camouflage Pattern is also a digital pattern in use by the U.S. Army.

For example, the recent computer generated patterns are some improvement over the former Woodlands design, but the patterns are still too discernable in close proximity and the large numbers of colors in a natural environment limits the versatility of the pattern.

It is therefore the primary object of the present invention to provide a novel crypsis camouflage pattern that is effective and is versatile for use in the desert as well as in woodland terrain for clothing, skin and other objects.

### DESCRIPTION OF THE DRAWINGS

FIG. 1 is a diagrammatic illustration of varying degrees of transparency of a color, such a black.

FIG. 2 is a representative sample of the camouflage design of the present invention as it appears on a portion of a garment.

### DETAILED DESCRIPTION

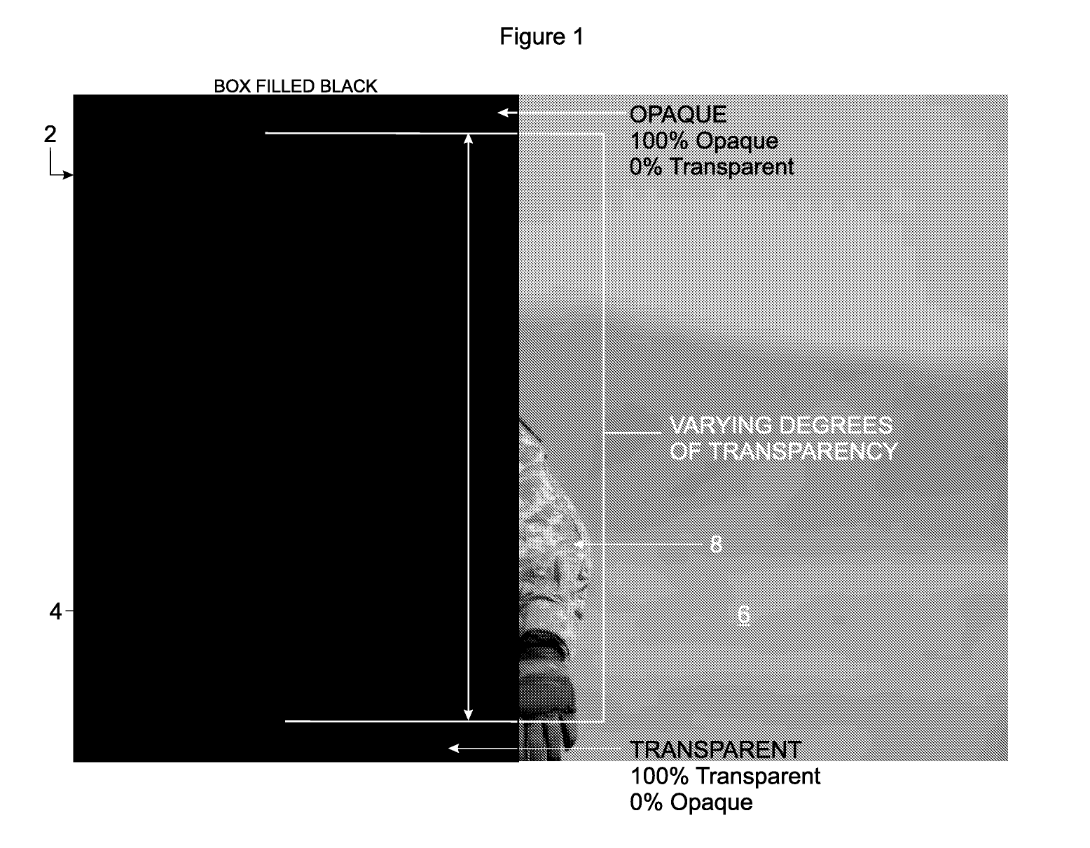

Traditionally, prior art camouflage designs, such as the US Woodland, the MARPAT and the Universal Camouflage Pattern have utilized opaque colors in various shapes and pixel formats. “Opaque” does not refer to any particular color. A color is opaque when it hides whatever is underneath. Opaque is the opposite of transparent. Reference is made to FIG. 1 to illustrate the opaque/transparent concept, utilizing the color black as an example. The rectangular box 2 is filled with black color. In back of the box 2 appears an image of a soldier 4 against a gray background 6. At the top of the box the black color is opaque, or 0% transparent, making the soldier's helmet impossible to see. At the bottom of the box 2, the black color is 100% transparent, allowing the soldier's battle dress uniform to be seen as clearly as that portion of the soldier's left arm 8 which is outside of the box. Between the top and the bottom of the box 2 the black color is seen to have gradually increasing degrees of transparency from 0% to 100%.

In another example, not illustrated, if the background color was sand, instead of gray, and the color cadmium red was substituted for the black in FIG. 1, the range of colors between red (opaque red) at the top of the box to sand (100% transparent red) at the bottom is a constantly changing new color of neither red nor sand, but an ever changing combination of the two. In a computer controlled printing or image transfer, digital control of transparency is well known.

Because the colors in the natural environment comprise an infinite number of colors and hues, the primary novelty of the present invention is to minimize the use of opaque colors and with the use of a small number of colors, each with varying degrees of transparency, the glut of colors found in sunlight and shadow of the natural environment are duplicated by this present camouflage design on an object to achieve the resemblance to the surroundings that is the goal of crypsis camouflage.

What has not been taught in the prior art is that although the background colors of foliage can vary tremendously, the colors of shadows, as the human eyes see them, are relatively universal in gray tones, with slight variations across different natural and unnatural light spectrums, assuming opacity of the camouflaged object relative to the intensity of the light and the distance between the object and the background on which the shadow is cast. When natural or artificial light is cast upon a natural or man-made 3-dimensional object, that object creates shadows against a background which vary in an order of opaque and higher resolution closest to the object, to increased transparency and more blurred farther from the object. The combinations of colors and shapes in the design of the present invention compliment the visual features of the human eye so as to increase the effectiveness of the camouflage.

The images of the present inventive camouflage design may be applied to fabric objects such as clothing or vehicles and structures. They may even be applied to the skin. Creation of the camouflage image starts with application to the transfer medium or object of a background which must be a color that suitably matches the natural surroundings found in a woodland setting, a snow scene or in a desert or arid environment. The preferred form of the design will be described as that being applicable to a woodland or forest setting but is not limited to the colors or designs referred to.

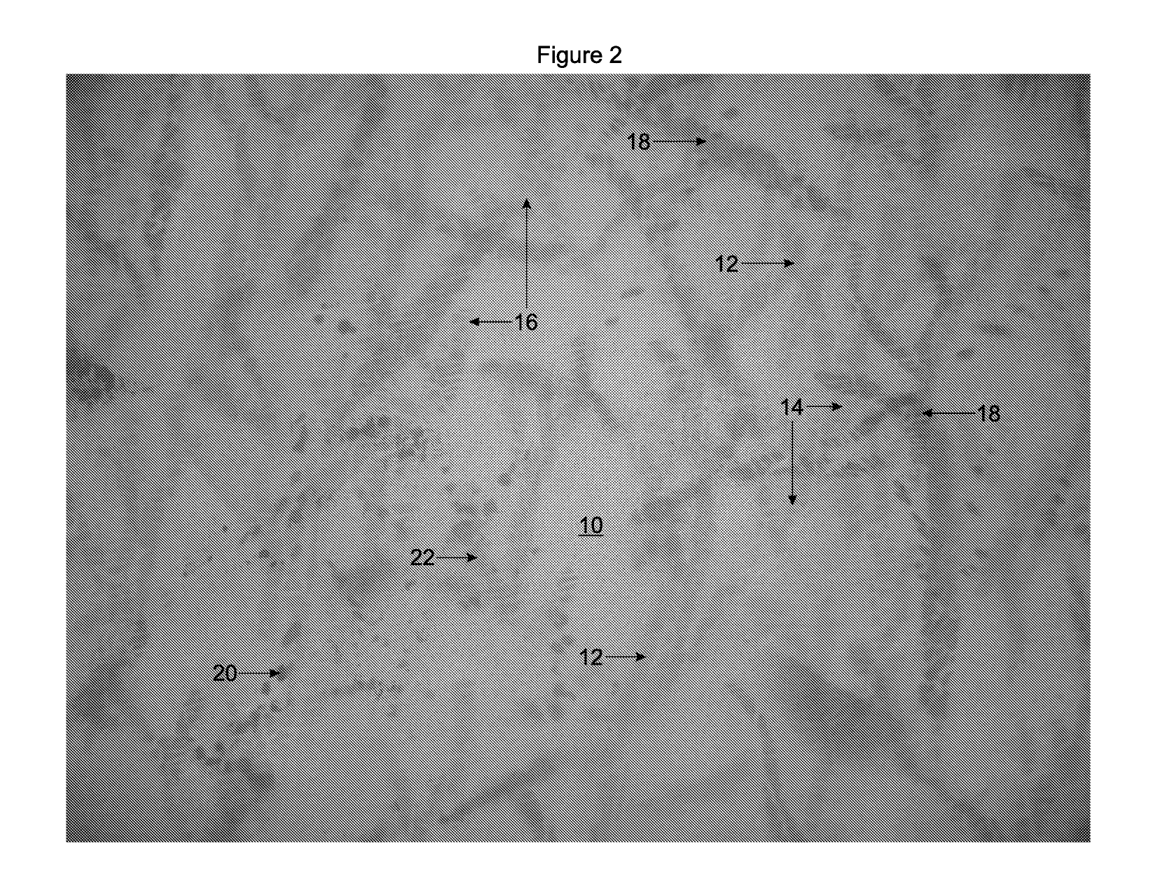

Referring to FIG. 2 as a representative example of the camouflage design of the present invention, a background color 10 is applied to at least a majority, if not all of the surface of the garment or object to be camouflaged. In the illustrated example the background is a sand color having, over the surface to which it is applied, varying degrees of opacity ranging from slight (80% transparent, for example) to opaque. Where the background color has slight transparency the underlying color of the object will be visible to some degree.

Applied over at least a portion of the background color 10 is a second color, which is light blue to gray, forming a plurality of randomly scattered forms 12, which, in the illustrated example, are elongate abstract representations of sticks, branches and fern-like leaves. The elongate objects may be divided, as referred to by numeral 14, as are the leaves of a fern, and they may be segregated or fragmented, as referred to by numeral 16, in order that the background color may show through the interstices in the objects. Like the background color, the second color has varying degrees of transparency, from opaque to a high degree of transparency.

Over the background and the second blue/gray color, one or more additional randomly scattered forms 18 may be applied, each with a color different than the previously applied colors and each with varying degrees of transparency. In the illustrated example the third application is a green color whose elongate abstract shapes are divided and fragmented and are applied randomly over at least a portion of the background and the second blue/gray application. The green colored objects also have a wide range of transparencies from opaque 20 to slightly transparent 22.

Additional applications of yet different and additional colors, with varying degrees of transparency, may be applied, however the real advantage of the present invention is that by using the transparency attributes of the applied colors that, when combined with the colors that underlie the applied color, the resultant surfeit of colors makes the use of more than two or three total colors unnecessary.

The camouflage design of the present invention is a synergistic combination that utilizes multi-dimensional and interconnected shapes and colors to produce an unexpectedly interactive system that camouflages in a desert environment in open sunlight while, at the same time, creating the appearance of a diffused, blurred, shadow-like effect in virtually any foliage or other environment.

1. A crypsis camouflage pattern for application to the surface area of an object, comprising,
covering at least a portion of the surface area of the object,
at least one additional color application, each superimposed over at least a portion of the surface area of the object and comprising a plurality of randomly scattered abstract forms, each of the applications being of a different color and each having varying degrees of transparency.

2. The camouflage pattern of claim 1 where the first background color is completely opaque.

3. The camouflage pattern of claim 1 where at least one of the abstract forms is elongate.

4. The camouflage pattern of claim 3 where at least one of the abstract forms is divided.

5. The camouflage pattern of claim 3 or 4 where at least one of the abstract forms is segmented.

6. A crypsis camouflage pattern for application to the surface area of an object, comprising,
covering at least a portion of the surface area of the object,
an application of second color superimposed over at least a portion of the surface area of the object and comprising a plurality of randomly scattered abstract forms having varying degrees of transparency,
an application of third color superimposed over at least a portion of the surface area of the object and comprising a plurality of randomly scattered abstract forms having varying degrees of transparency.

7. The camouflage design of claim 6 where the abstract forms are divided and fragmented.

8. The camouflage design of claim 7 where the varying degrees of transparency include opaque.
